(19) United States
(12) Patent Application Publication
(10) Pub. No.: US 2022/0368641 A1
(43) Pub. Date: Nov. 17, 2022

(54) MITIGATION OF INTER-STREAM DELAY JITTER

(71) Applicant: NOKIA SOLUTIONS AND NETWORKS OY, Espoo (FI)

(72) Inventors: Hua CHAO, Shanghai (CN); He WANG, Shanghai (CN)

(21) Appl. No.: 17/767,290

(22) PCT Filed: Oct. 17, 2019
(86) PCT No.: PCT/CN2019/111768

§ 371 Date: Apr. 7, 2022

(51) Int. Cl. H04L 47/24

(52) U.S. Cl. CPC H04L 47/24

(57) ABSTRACT

Embodiments of the present disclosure relate to devices, methods, apparatuses and computer readable storage media of the mitigation of inter-stream delay jitter. The method comprises in accordance with a determination that a plurality of data flows are to be transmitted from a second device to a third device, determining, at a first device, an egress port of the third device for the plurality of data flows to pass through based on a traffic class of the plurality of data flows; determining a processing pattern of the plurality of data flows for the egress port, the processing pattern indicating an association between the plurality of data flows; and providing the processing pattern to a second device. In this way, a correct transmission order for packets associated with different QoS flows through a same egress port may be guaranteed, so the inter-stream delay jitter may be mitigated.

### FIELD

Embodiments of the present disclosure generally relate to the field of telecommunication and in particular, to devices, methods, apparatuses and computer readable storage media for mitigation of inter-stream delay jitter.

### BACKGROUND

The modern communications era has brought about a tremendous expansion of communication networks in order to provide efficient and reliable solutions for communication. Each new generation has its own technical challenges for handling the different situations and processes that are needed to connect and serve devices connected to the communication networks. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

It is expected that a wireless communication network can also support automotive industry and industry automation which are time sensitive services. Thus, research has begun on how to integrate a wireless communication network into a time-sensitive network (TSN) which is typically a wired communication network. It is to evolve the supported use cases for higher requirements, e.g. factory automation, transport industry and electrical power distribution.

### SUMMARY

In general, example embodiments of the present disclosure provide a solution for mitigation of inter-stream delay jitter.

In a first aspect, there is provided a first device. The first device comprises at least one processor; and at least one memory including computer program codes; the at least one memory and the computer program codes are configured to, with the at least one processor, cause the first device at least to in accordance with a determination that a plurality of data flows are to be transmitted from a second device to a third device, determine, at the first device, an egress port of the third device for the plurality of data flows to pass through based on a traffic class of the plurality of data flows; determine a processing pattern of the plurality of data flows for the egress port, the processing pattern indicating an association between the plurality of data flows; and provide the processing pattern to a second device.

In a second aspect, there is provided a second device. The second device comprises at least one processor; and at least one memory including computer program codes; the at least one memory and the computer program codes are configured to, with the at least one processor, cause the second device at least to in response to receiving a data packet at the second device, determine, based on a processing pattern of a plurality of data flows for an egress port of a third device, whether the data packet is associated with the plurality of data flows, the processing pattern indicating an association between the plurality of data flows; in accordance with a determination that the data packet is associated with the plurality of data flows, determine a sequence number of the data packet, the sequence number indicating a time order for transmitting the data packet from the egress port of the third device to a fourth device; mark the data packet with the sequence number; and transmit the marked data packet to the third device.

In a third aspect, there is provided a third device. The third device comprises at least one processor; and at least one memory including computer program code; where the at least one memory and the computer program code are configured to, with the at least one processor, cause the third device to receive a data packet from a second device, the data packet being associated with a plurality of data flows to be transmitted from an egress port of the third device; determine a sequence number of the data packet, the sequence number indicating a time order for transmitting the data packet from the egress port to a fourth device; and transmit the data packet to the fourth device based on the sequence number.

In a fourth aspect, there is provided a method. The method comprises in accordance with a determination that a plurality of data flows are to be transmitted from a second device to a third device, determining, at a first device, an egress port of the third device for the plurality of data flows to pass through based on a traffic class of the plurality of data flows; determining a processing pattern of the plurality of data flows for the egress port, the processing pattern indicating an association between the plurality of data flows; and providing the processing pattern to a second device.

In a fifth aspect, there is provided a method. The method comprises in response to receiving a data packet at a second device, determining, based on a processing pattern of a plurality of data flows for an egress port of a third device, whether the data packet is associated with the plurality of data flows, the processing pattern indicating an association between the plurality of data flows; in accordance with a determination that the data packet is associated with the plurality of data flows, determining a sequence number of the data packet, the sequence number indicating a time order for transmitting the data packet from the egress port of the third device to a fourth device; marking the data packet with the sequence number; and transmitting the marked data packet to the third device.

In a sixth aspect, there is provided a method. The method comprises receiving, at a third device, a data packet from a second device, the data packet being associated with a plurality of data flows to be transmitted from an egress port of the third device; determining a sequence number of the data packet, the sequence number indicating a time order for transmitting the data packet from the egress port to a fourth device; and transmitting the data packet to the fourth device based on the sequence number.

In a seventh aspect, there is provided an apparatus comprising means for in accordance with a determination that a plurality of data flows are to be transmitted from a second device to a third device, determining, at a first device, an egress port of the third device for the plurality of data flows to pass through based on a traffic class of the plurality of data flows; means for determining a processing pattern of the plurality of data flows for the egress port, the processing pattern indicating an association between the plurality of data flows; and means for providing the processing pattern to a second device.

In an eighth aspect, there is provided an apparatus comprising means for in response to receiving a data packet at a second device, determining, based on a processing pattern of a plurality of data flows for an egress port of a third device, whether the data packet is associated with the plurality of data flows, the processing pattern indicating an association between the plurality of data flows; means for in accordance with a determination that the data packet is associated with the plurality of data flows, determining a sequence number of the data packet, the sequence number indicating a time order for transmitting the data packet from the egress port of the third device to a fourth device; means for marking the data packet with the sequence number; and means for transmitting the marked data packet to the third device.

In a ninth aspect, there is provided an apparatus comprising means for receiving, at a third device, a data packet from a second device, the data packet being associated with a plurality of data flows to be transmitted from an egress port of the third device; means for determining a sequence number of the data packet, the sequence number indicating a time order for transmitting the data packet from the egress port to a fourth device; and means for transmitting the data packet to the fourth device based on the sequence number.

In a tenth aspect, there is provided a non-transitory computer readable medium comprising program instructions for causing an apparatus to perform at least the method according to any one of the above fourth to sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication architecture in which example embodiments of the present disclosure may be implemented;

FIG. 2 illustrates an example showing that the transmission of data flows between TSN end device via radio access network according to some example embodiments of the present disclosure;

FIG. 3 illustrates a signaling chart illustrating a process according to some example embodiments of the present disclosure;

FIG. 4 shows a flowchart of an example method 400 of mitigation of inter-stream delay jitter according to some example embodiments of the present disclosure;

FIG. 5 shows a flowchart of an example method 500 of mitigation of inter-stream delay jitter according to some example embodiments of the present disclosure;

FIG. 6 shows a flowchart of an example method 600 of mitigation of inter-stream delay jitter according to some example embodiments of the present disclosure;

FIG. 7 shows a simplified block diagram of a device that is suitable for implementing example embodiments of the present disclosure; and

FIG. 8 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one example embodiment,” “an example embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Ethernet or Institute of Electrical and Electronic Engineers (IEEE), and/or any other technologies currently known or to be developed in the future. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and/or receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, smart appliances, networked industry products, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

With evolution of communication techniques, it has been proposed to integrate a wireless communication network into a time-sensitive network (TSN), as mentioned above. For example, the 5G communication network may be incorporated into the TSN. Current TSN is based on a set of IEEE standards (such as IEEE 802.1 standards) that aim to make Ethernet more deterministic for safety-critical and real-time services. Communications supported by the TSN may be referred to as time sensitive communication (TSC) in the wireless communication network. Some main goals of the TSN are to provide time synchronization and timeliness (deterministic latency and reliability/redundancy) for a variety of time-sensitive services coexisting on a network that also supports best effort traffic. TSN is expected to be widely used in many modern cyber-physical systems, from industry automation to in-vehicle networking, for example. The real-time capabilities of TSN will have the potential to support more scenarios in communication systems. The wireless communication network is also evolved to provide more diversity services such as enhanced mobile broadband (eMBB), massive machine type communication (mMTC) and ultra-reliable low latency communication (URLLC). Those services may be time sensitive in some applications such as in automotive industry and industry automation.

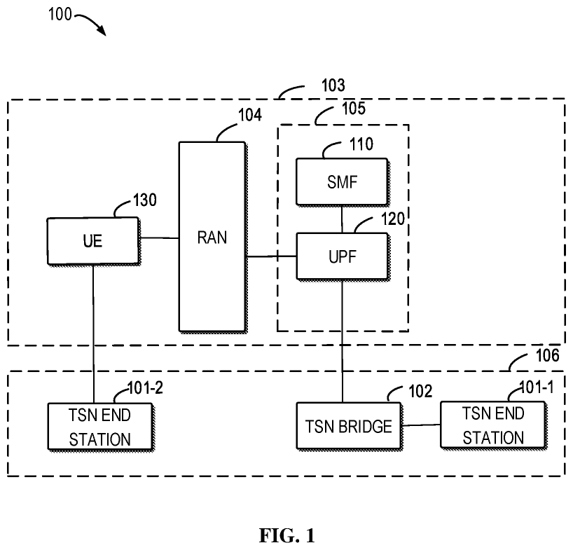

It has been proposed that the whole wireless communication network would logically work as a network node in the TSN (such as in an end-to-end (E2E) TSN) to communicate with other network nodes in the TSN. Such network node is also referred to as a bridge or a router in the TSN. FIG. 1 illustrates example communication architecture 100 in which a wireless communication network 103 is integrated with a TSN 106. Some example embodiments of the present disclosure may be implemented in such architecture.

As shown, a wireless communication network 102 works as a logical TSN bridge, which may also be referred to as a wireless TSN bridge. The wireless communication network 103 is integrated with another network, i.e., the TSN 106, which includes one or more network devices to support communications between terminal devices. As shown, the TSN 106 includes a TSN bridge 102 and so on for routing traffic among end stations, including end stations 101-1, 101-2 (collectively or individually referred to as end stations 101, also referred to as a “fourth device” 101 sometimes). In the integrated deployment shown in FIG. 1, the wireless TSN bridge corresponding to the wireless communication network 103 is typically provided as the first hop of bridge or the last hop of bridge in a communication path from two end stations, such that the wireless TSN bridge is directly connected to one or more end stations 101, for example, via an UE 130 (also referred to as a “third device” 130 or “second device” 130 sometimes) for the wireless communication network 103.

In some example embodiments, the wireless communication network 103 may be a 5G system (5GS). In other embodiments, the wireless communication network 103 may be any other type of wireless communication systems or networks, such as the 4G system, the 3G system, or the like. The wireless communication network 103 includes a RAN 104, which may be deployed to provide communications based on any radio access technologies. In the network integration, the RAN 104 may be considered as a part of the logical wireless TSN bridge. In the example where the wireless communication network 103 is a 5GS, the wireless TSN bridge may sometimes be referred to as a 5GS TSN bridge. The names can be varied for such logical TSN bridge corresponding to the wireless communication network.

In addition to the RAN 104, the wireless communication network 103 may also include a core network (CN) 105, where network function (NF) elements contained therein can also be considered logically as working in the wireless TSN bridge. The CN 105 may further include one or more NF elements to support a user plane (UP) function, including a user plane function (UPF) 120 (also referred to as a “second device” 120 or “third device” 120 sometimes). The UPF 120 is configured for forwarding of traffic communicated between the RAN 104 and the TSN 106. The UPF 120 may include a network TSN translator (NW-TT, not shown in FIG. 1) to perform the forwarding, which generally performs address mapping between two networks 103 and 106. The UPF 120 is also capable of buffering traffic received from one of the wireless communication network 103 and TSN 106 before forwarding the traffic into the other network.

The CN 105 also includes a Session Management Element (SMF) 110 (also referred to as a “first device” 120 sometimes) to implement a session management function in the CN 105. The SMF is primarily responsible for interacting with the decoupled data plane, creating updating and removing Protocol Data Unit (PDU) sessions and managing session context with the UPF 120.

The SMF 110 and the UPF 120 in the CN 105 may also be referred to as core network devices 110 and 120, respectively. Each of the SMF 110 and the UPF 120 can be implemented by one or more physical devices or servers.

The granularity of the logical wireless TSN bridge is per UPF. That is, each combination of the UE 130, the RAN 104, the CN 105, and a different UPF 120 can be logically considered as a different wireless TSN bridge. FIG. 1 only shows one UPF 120 and accordingly one wireless TSN bridge. If there is another UPF deployed therein, the UE 130 the RAN 104, the CN 105, and the other UPF can form another logical wireless TSN bridge. The number of logical wireless TSN bridges thus depends on the number of UPFs, which is not limited here. In some implementations, one UPF may be connected to one or more network devices (not shown in FIG. 1) in the RAN 104.

The UE 130 is capable of accessing the RAN 104 and may be referred to as a wireless communication terminal. To enable communication, the UE 130 establishes a connection with one or more of the network devices in the RAN 104. The UE 130 can also link to end stations of the TSN 106, such as the end station 101-1, and receive data to be transmitted from the end station 101-1. In the case that the UE 130 has established a connection with a network device in the RAN 110, the network device can operate to communicate traffic from the UE 130 to another TSN end station 101-2 through the TSN 106. As such, traffic of the TSN end station 101-1 is passed to the TSN end station 101-2 through the wireless network 103 and the TSN bridge 102. The communication can be achieved likewise in a reverse direction from the end station 101-2 to the end station 101-1. In some cases, the UE 130 may originally send traffic to the end station 101-2 and receive traffic from the end station 101-2 as a destination.

The TSN end stations 101 may be any type of terminal devices supporting communication in the TSN 106. In many cases, the UE 130 may be a mobile device supporting wireless communication with the RAN 104. Of source, other types of terminal devices in the RAN 104 may also be possible. By integrating the wireless communication network 103 and the TSN 106, the flexible wireless connectivity in wider areas through the mobile terminals can support a wide range of different use cases and application in various fields. The TSN end stations 101 can take benefits from the native flexible mobility in the wireless communication, which enables easily reconfigurable factories, reduce installation, and maintenance of wires cost, and also allows innovative uses of mobile robots and mobile platforms with automatic guided vehicle (AGV) in automation scenarios.

The SM and UP functions in the wireless TSN bridge are included to be compatible with the TSN functions and procedure in the TSN 106. The SMF 110 and the UPF 120 may be configured to interact and map the TSN features and RAN features. Generally, the wireless TSN bridge may operate to satisfy the characteristic required for the

TSN 106. Some main characteristics includes time synchronization in all network nodes (including the bridges) in the TSN, such as defined in the IEEE 802.1AS standard based on the 1588 Precision Time Protocol; scheduling and traffic shaping (such as defined in the IEEE 802.1 Qbv standard); transmission path selection, resource reservation (such as defined in the IEEE 802.1 Qcc standard), and fault-tolerance (such as defined in the IEEE 802.1 CB standard); and so on.

Furthermore, for QoS mapping in RAN 104, the following ways for different network functions are defined. The SMF 110 provides the DL Packet Detection Rule (PDR) to the UPF 120 to enabling DL packet classification and optional QoS flow marking with Reflective QoS Indication. For each Service Data Flow (SDF), when applicable, the SMF 110 generates an explicitly signaled QoS rule and provides it to the UE 130 for UL QoS flow mapping from IP packets to QoS flows. In RAN 104, the Service Data Adaptation Protocol (SDAP) sublayer binds the QoS flows to Radio Bearers (RBs) based on QoS information received from the SMF 110.

Latency, reliability and jitter are the main Key Performance Indicators for Time sensitive communication (TSC). To achieve the low latency requirement of TSN, the scheduling for TSC QoS flow is Configured Grant (CG) for the UL and Semi-Persistent Scheduling (SPS) for the DL. To guarantee the transmission reliability, PDCP duplication is agreed to apply to the TSC. Up to 4 legs/copies are agreed per radio bearer (RB) towards achieving consistent reliability using several concurrent radio links that dynamically vary in reliability and latency. There is one PDCP entity per RB per UE. Jitter requirements vary between different use cases. In most use cases, jitter is up to 50% of cycle time.

As mentioned above, TSN streams from/to the same TSN end station 101 may be forwarded via the same wireless TSN bridge, e.g. via an ingress port and an egress port, which may be referred to as a port pair. Ethernet is a time-division system. Therefore, packets belong to those TSN streams could only arrive the NW-TT of the UPF 120 at the ingress port in time-division. Scheduling resolution of Ethernet is traffic class. It means that if different TSN streams are transmitted to the same egress port belong to the same traffic class, they will be forwarded to the same transmission queue.

With above characteristics, transmission sequence for different TSN streams going through the ingress port is the same as they go through the egress port for a certain TSN bridge. The wireless TSN bridge, as one of the parts of the TSN network, shall obey the same transmission feature. However, it is not case in practice.

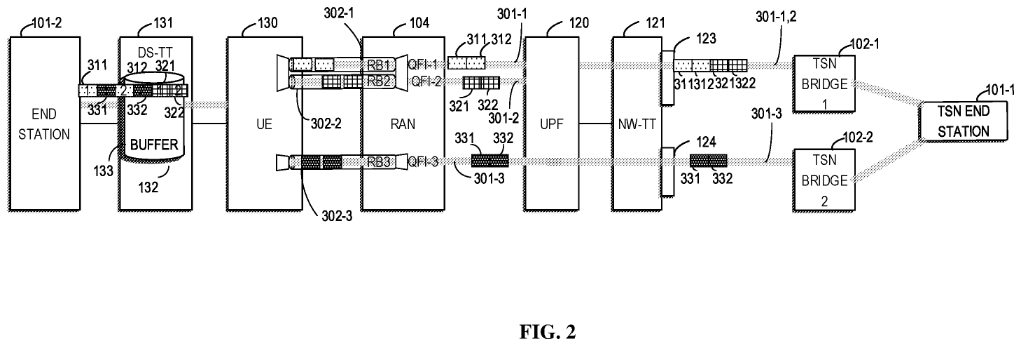

With reference to FIG. 2, the issue of delay jitter, which may also be referred to as inter-stream delay jitter will be explained. As shown in FIG. 2, taking the downlink as an example to explain, it is assumed that TSN streams 301-1, 301-2 and 301-3 from the TSN bridge 102-1 and 102-2 belong to the same traffic class. As shown in FIG. 2, the packet bursts belong to TSN streams 301-1, 301-2 and 301-3 arrive in the ingress port 123 and 124 in time t1, t2 and t3 respectively, where t1<t3<t2. However, those received SDAP SDUs in the UE may not obey this order. The difference may change from traffic burst to traffic burst. The jitter of the transmission time sequence for more than one traffic flow is called as inter-stream jitter.

For example, the transmission of different TSN streams or TSC QoS flows in the same time via different RBs may cause the inter-stream delay jitter. Furthermore, mismatch between the periodicity of TSN stream and CG/SPS traffic periodicities may also lead to introduce inter-stream delay jitter. Moreover, due to time-varying characteristics of radio channel and PDCP duplication function for TSC, each TSC packet may be received in the PDCP from different legs/copies and they may experience different radio interface delay in a consequence.

Thus, the present disclosure proposes a solution for mitigation of inter-stream delay jitter, especially for TSN packets forwarding from the UE to the Device Side TSN Translator (DS-TT), which may be implemented in the UE, as well as from the UPF to the

NW-TT to the same egress port. The SMF 110 may create a processing pattern for a data flow per a certain egress port and provide the processing pattern to UPF 120 and the UE 130. The data flow herein may be referred to as “TSC QoS flow.” Based on the processing pattern, the UPF 120 and the UE may mark the packets, from different TSC QoS flows and to be transmitted to a same egress port, with a sequence number, to cause the transmission time sequence for different TSC QoS flows going through the ingress port is the same as they go through the egress port for a certain TSN bridge.

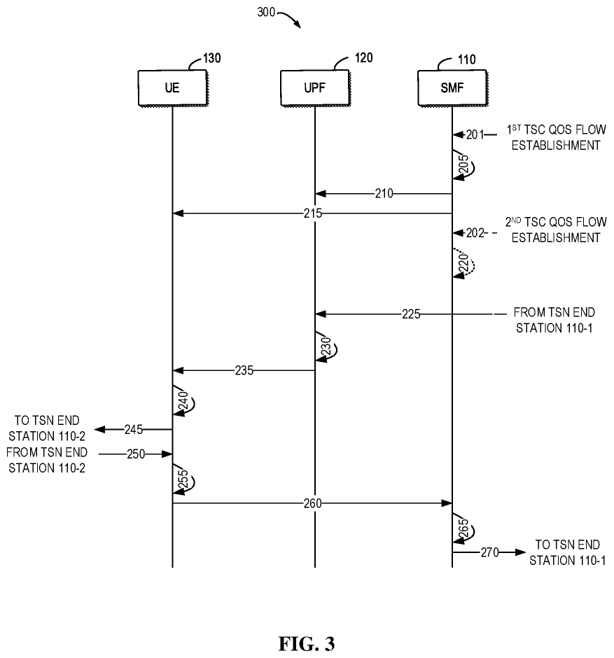

Principle and embodiments of the present disclosure will be described in detail below with reference to the accompanying drawings. Reference is now made to FIG. 3, which shows a signaling chart of a process 300 for handover according to some example embodiments of the present disclosure. The process 300 can be implemented in communication architecture with two types of networks integrated, such as the one shown in FIG. 1. For the purpose of discussion, the process 300 will be described with reference to FIGS. 1 and 2. The process 300 may involve a SMF 110, a UPF 120 and a UE 130 as illustrated in FIG. 1. It would be appreciated that although the process 200 for handover has been described in the architecture 100 of FIG. 1 where a wireless communication network and a wired communication network (such as a TSN) are integrated, this process may be likewise applied to other communication architecture with two different types of networks integrated. For the purpose of simplify, some functions, elements, entities and devices are omitted in FIG. 2.

In the process 300, the SMF 110 may receive 201 a trigger for TSC QoS flow establishment. For example, the TSC QoS flow may be transmitted from the end TSN station 101-1 to the end TSN station 101-2 through RAN 104. The SMF 110 may determine a traffic class of the TSC QoS flow. Based on the traffic class of the TSC QoS flow, the SMF 110 may determine an egress port, through which the TSC QoS flow could be transmitted to the end TSN station 101. For example, if the QoS flow is transmitted from the UPF 120 to the UE 130, the egress port may be referred to an egress port at the

UE 130. On the contrary, if the QoS flow is transmitted from the UE 130 to the UPF 120, the egress port may be referred to an egress port at the UPF 120. The mapping between the traffic class and the egress port is configured by the TSN network to the wireless communication network.

Upon the determination of the egress port, the SMF 110 may determine whether a trigger for another TSC QoS flow with this traffic class has been received. If not, the SMF 110 determines 205 a processing pattern applicable for the TSC QoS flow. The processing pattern may be generated based on the property of the TSC QoS flow. For example, the property may comprise the direction of the TSC QoS flow, i.e. a UL TSC QoS flow or a DL TSC QoS flow. The property may also comprise an identifier of the PDU session (PDU session ID) associated with the TSC QoS flow and the indicator of the TSC QoS flow (QFI). The SMF 110 may set a pattern identifier for this processing pattern. For example, a processing pattern for a certain egress port may be represent as below:

TABLE 1
An example of processing pattern

| Pattern identifier | Direction | PDU session ID | List of QFIs |
|---|---|---|---|
| 1 | DL | PDU session 1 | QFI-1 |

As shown in Table 1, for a certain egress port, the SMF 110 creates the processing pattern 1, which maintains the association between the egress port and the corresponding property of the TSC QoS flow including a DL direction, PDU session 1 and QFI-1.

For a DL QoS, the processing pattern may be transmitted 210 from the SMF 110 to the UPF 120. For a UL flow, the processing pattern may be transmitted 210 from the SMF 110 to the UE 130. In some example embodiments, the SMF 110 may transmit the processing pattern to the UPF 120 via a N4 session Establishment/Modification request. In some example embodiments, the SMF 110 may the processing pattern to the UE 130 via a NAS signaling as the same way as transmitting the QoS rules.

In some example embodiments, when the SMF 110 further receives 202 a trigger for a new TSC OoS flow establishment and the new TSC OoS flow has a same traffic class and the same egress port with the previous TSC QoS flow, i.e. the TSC QoS flow numbered QFI-1. The SMF 110 may update 220 the processing pattern based on the new TSC OoS flow. For example, the indicator of the new TSC QoS flow may be added into the processing pattern 1. For example, the if new TSC QoS flow numbered as QFI-2, the updated processing may be represented as below:

TABLE 1
An example of processing pattern

| Pattern identifier | Direction | PDU session ID | List of QFIs |
|---|---|---|---|
| 1 | DL | PDU session 1 | QFI-1, QFI-2 |

That is, for a processing pattern for the plurality of TSC QoS flows, the processing pattern may indicate the association between the plurality of TSC QoS flows in their properties.

Correspondingly, if the SMPF 110 receives a trigger of the TSC QoS flow release, the SMF may also update the processing pattern by removing the indicator of the TSC flow from the processing pattern.

Hereafter, the processing of the packets associated with TSC QoS flows with the same traffic class will be explained with reference to FIG.2 as below. The processing pattern may involve 3 TSC QoS flows numbered QFI-1, QFI-2 and QFI-3, respectively.

Taking a DL packet as an example, the UPF 120 receives 225 a packet 311 from the TSN end station 110-1 via a TSN bridge 102-1. The UPF 120 may determine whether the packet 311 is associated with a TSC QoS flow indicated in the processing pattern. The UPF 120 may map to the packet 311 to TSC a QoS flow based on Packet Detection Rules (PDR). If the UPF 120 determines the packet 311 is associated with a TSC QoS flow, for example, QFI-1, the UPF 120 may determine a sequence number for the packet 311.

In some example embodiments, the UPF 120 may determine how many packets in a packet burst belonging to the TSC QoS flow numbered OFI-1 have been arrived at the UPF 120 and their chronological order, when the packet 311 arrives at the UPF 120, for example, at the ingress port 123 of the NW-TT 121. Based the number of packets belonging to the plurality of data flows which have been arrived at the UPF 120 and the timestamp, the UPF 120 may determine the sequence number for the packet 311. For example, the packet 311 may be the first packet belonging to the TSC QoS flow numbered OFI-1 which has been arrived at the UPF 120 and also the first packet in all TSC QoS flows which has been arrived at the UPF 120. Similarly, the UPF 120 may also determine the sequence number for other packets, i.e. packet 312 belonging to the TSC QoS flow numbered OFI-1 and packets 321 and 322 belonging to the TSC QoS flow numbered OFI-2.

Also, the UPF 120 may also determine the sequence number for packets 331 and 332, transmitted from the TSN end station 110-1 via a TSN bridge 102-2 to the ingress port 124 of the NW-TT 121, belonging to the TSC QoS flow numbered OFI-3 shown in FIG. 3 in a same way.

The UPF 120 then mark 230 the packets mentioned above with corresponding sequence number. In some example embodiments, the UPF 120 may insert the sequence number to the option bit in the head of the packets.

Then the UPF 120 may transmit 235 the marked packets to the UE 130 via RAN 104. The marked packets may be transmitted to the UE 130 via different radio bearers (RB) 302-1, 302-1 and 302-3.

If the UE 130 receives the packets from one or more network devices (not shown) of RAN 104, the UE 130 may determine 240 the sequence number of the packets. The UE 130 may forward these packets to a buffer after removing the sequence number, which may be called as hold-and-forward buffer 133 in the DS-TT 131 in the chronological order indicated by the sequence number of these packets, so than these packets will be transmitted 245 to the TSN end station 101-2 through the egress port 133 at the DS-TT 131 according to the chronological order same as they arrive at the ingress ports 123 and 124 at the NM-TT 221.

For a UL packet transmitted from the TSN end station 101-2 to the UE 130, the UE 130 may also map the UL packet to an associated TSC QoS flow based on QoS rules or reflective QoS mapping. The actions 255 and 260 of the UE 130 may be similar with the actions 230 and 235 of the UPF 120, and the actions 265 and 270 of the UPF 120 may be similar with the actions 240 and 245 of the UE 130. Thus, the description may be omitted.

In this way, a correct transmission order for packets associated with different TSC QoS flows through a same egress port may be guaranteed, so the inter-stream delay jitter may be mitigated.

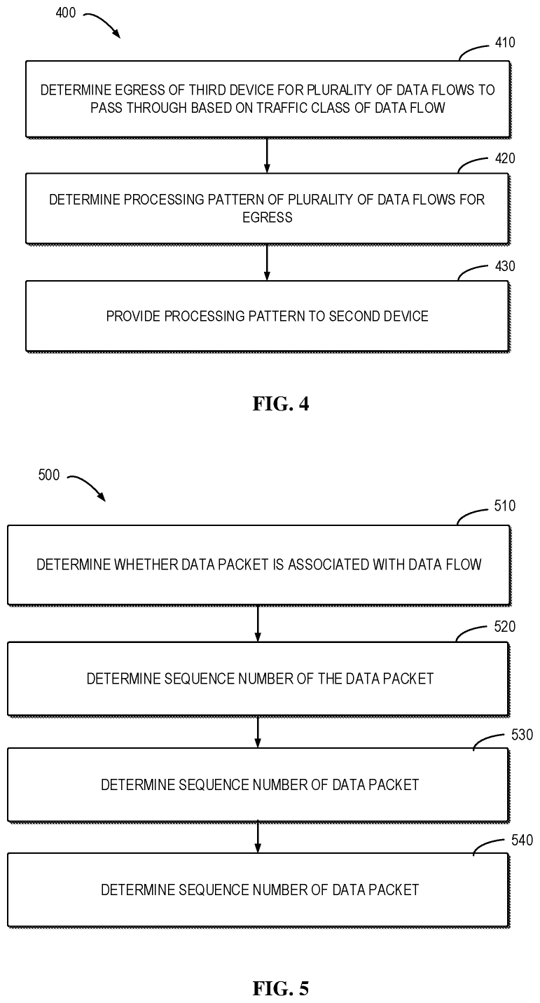

FIG. 4 shows a flowchart of an example method 400 of mitigation of inter-stream delay jitter according to some example embodiments of the present disclosure. The method 400 can be implemented at the first device 110 as shown in FIG. 1. For the purpose of discussion, the method 400 will be described with reference to FIG. 1.

As shown in FIG. 4, at 410, the first device 110 determines an egress port of the third device for the plurality of data flows to pass through based on a traffic class of the plurality of data flows if the first device 110 determines that a plurality of data flows are to be transmitted from a second device 120 to a third device 130.

At 420, the first device 110 determines a processing pattern of the plurality of data flows for the egress port. The processing pattern may indicate an association between the plurality of data flows.

In some example embodiments, the first device 110 may determine a property of the plurality of data flows and set a pattern identifier of the property of the plurality of data flows. The first device 110 may further determine the processing pattern based on the pattern identifier and the property of the plurality of data flows. The property comprises at least one of the following: a transmission direction of the plurality of data flows, a session identifier of a data unit session associated with the plurality of data flows, and an indicator of the plurality of data flows.

At 430, the first device 110 provides the processing pattern to a second device.

In some example embodiments, the first device 110 may also determine whether a further traffic class of the further data is same as the traffic class of the plurality of data flows, if a further data flow are to be transmitted from a second device to a third device. The first device 110 may also determine a property of the further data flow and update the processing pattern based on the property of the further data flow if the further traffic class is same as the traffic class.

In some example embodiments, the first device 110 may also remove the property of the plurality of data flows from the processing pattern if the first device 110 determines that the transmission of the plurality of data flows has been released.

FIG. 5 shows a flowchart of an example method 500 of mitigation of inter-stream delay jitter according to some example embodiments of the present disclosure. The method 500 can be implemented at the second device 120 as shown in FIG. 1. For the purpose of discussion, the method 500 will be described with reference to FIG. 1.

As shown in FIG. 5, at 510, the second device 120 determines whether a data packet is associated with the plurality of data flows based on a processing pattern of a plurality of data flows for an egress port of a third device 130, if the data packet is received at the second device 120. The processing pattern may indicate an association between a property of the plurality of data flows.

At 520, the second device 120 determines a sequence number of the data packet if the data packet is associated with the plurality of data flows. The sequence number may indicate a time order for transmitting the data packet from the egress port of the third device to a fourth device.

At 530, the second device 120 marks the data packet with the sequence number and at 540, transmits the marked data packet to the third device.

In some example embodiments, the second device 120 may determine a property of the plurality of data flows based on the processing pattern, the property comprising at least one of the following: a direction of the plurality of data flows, a session identifier of a data unit session associated with the plurality of data flows, and an indicator of the plurality of data flows and identification information of the data packet. The second device 120 may determine the data packet is associated with the plurality of data flows if the identification information matches the properties.

In some example embodiments, the second device 120 may determine the number of data packets belonging to the plurality of data flows which have been arrived during a packet burst at the second device and a time sequence of the data packet in the packet burst arrives at the second device. The second device 120 may further determine the sequence number based on the number and the timestamp.

In some example embodiments, the second device 120 may insert the sequence number into a head of the data packet.

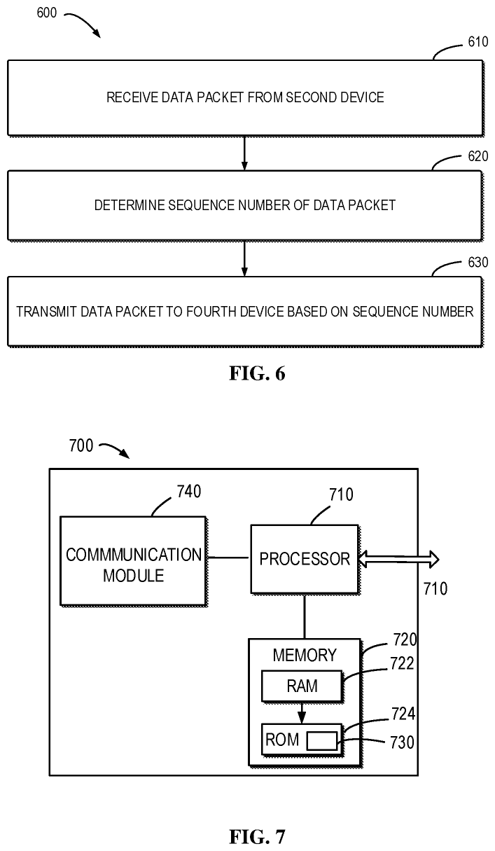

FIG. 6 shows a flowchart of an example method 600 of mitigation of inter-stream delay jitter according to some example embodiments of the present disclosure. The method 600 can be implemented at the third device 130 as shown in FIG. 1. For the purpose of discussion, the method 600 will be described with reference to FIG. 1.

As shown in FIG. 6, at 610, the third device 130 receives a data packet from a second device, the data packet being associated with a plurality of data flows to be transmitted from an egress port of the third device.

At 620, the third device 130 determines a sequence number of the data packet, the sequence number indicating a time order for transmitting the data packet from the egress port to a fourth device.

At 630, the third device 130 transmits, based on the sequence number, the data packet to the fourth device through the egress port.

In some example embodiments, the third device 130 may remove the sequence number from the data packet before the transmission of the data packet before the through the egress port.

In some example embodiments, the third device 130 may determine the sequence number from a head of the data packet.

In some example embodiments, an apparatus capable of performing the method 400 (for example, implemented at the first device 110) may comprise means for performing the respective steps of the method 400. The means may be implemented in any suitable form. For example, the means may be implemented in a circuitry or software module.

In some example embodiments, the apparatus comprises means for in accordance with a determination that a plurality of data flows are to be transmitted from a second device to a third device, determining, at a first device, an egress port of the third device for the plurality of data flows to pass through based on a traffic class of the plurality of data flows; means for determining a processing pattern of the plurality of data flows for the egress port, the processing pattern indicating an association between the plurality of data flows; and means for providing the processing pattern to a second device.

In some example embodiments, an apparatus capable of performing the method 500 (for example, implemented at the second device 120) may comprise means for performing the respective steps of the method 500. The means may be implemented in any suitable form. For example, the means may be implemented in a circuitry or software module.

In some example embodiments, the apparatus comprises means for in response to receiving a data packet at a second device, determining, based on a processing pattern of a plurality of data flows for an egress port of a third device, whether the data packet is associated with the plurality of data flows, the processing pattern indicating an association between the plurality of data flows; means for in accordance with a determination that the data packet is associated with the plurality of data flows, determining a sequence number of the data packet, the sequence number indicating an time order for transmitting the data packet from the egress port of the third device to a fourth device; means for marking the data packet with the sequence number; and means for transmitting the marked data packet to the third device.

In some example embodiments, an apparatus capable of performing the method 600 (for example, implemented at the third device 130) may comprise means for performing the respective steps of the method 600. The means may be implemented in any suitable form. For example, the means may be implemented in a circuitry or software module.

In some example embodiments, the apparatus comprises means for means for receiving, at a third device, a data packet from a second device, the data packet being associated with a plurality of data flows to be transmitted from an egress port of the third device; means for determining a sequence number of the data packet, the sequence number indicating a time order for transmitting the data packet from the egress port to a fourth device; and means for transmitting based on the sequence number, the data packet to the fourth device through the egress port.

FIG. 7 is a simplified block diagram of a device 700 that is suitable for implementing embodiments of the present disclosure. The device 700 may be provided to implement the communication device, for example the first device 110, the second device 120 and the third device 130 as shown in FIG. 1. As shown, the device 700 includes one or more processors 710, one or more memories 740 coupled to the processor 710, and one or more transmitters and/or receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

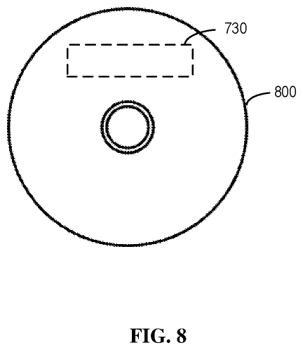

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400, 500 and 600 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
the at least one memory and the computer program code are configured to, with the at least one processor, cause the first device at least to:
in accordance with a determination that a plurality of data flows are to be transmitted from a second device to a third device, determine, at the first device, an egress port of the third device for the plurality of data flows to pass through based on a traffic class of the plurality of data flows;
determine a processing pattern of the plurality of data flows for the egress port, the processing pattern indicating an association between the plurality of data flows; and
provide the processing pattern to a second device.

2. The first device of claim 1, wherein the first device is caused to determine the processing pattern by:
determining a property of the plurality of data flows, the property comprising at least one of the following: a transmission direction of the plurality of data flows, a session identifier of a data unit session associated with the plurality of data flows, and indicators of the plurality of data flows;
setting a pattern identifier for the property of the plurality of data flows; and
determining the processing pattern based on the pattern identifier and the property of the plurality of data flows.

3. The first device of claim 1, wherein the first device is further caused to:
in accordance with a determination that a further data flow is to be transmitted from a second device to a third device, determine whether a further traffic class of the further data is same as the traffic class of the plurality of data flows;
in accordance with a determination that the further traffic class is same as the traffic class, determine a property of the further data flow; and
update the processing pattern based on the property of the further data flow.

4. The first device of claim 1, wherein the first device is further caused to:
in accordance with a determination that the transmission of the plurality of data flows has been released, remove the property of the plurality of data flows from the processing pattern.

5. A second device, comprising:
at least one processor; and
at least one memory including computer program code;
the at least one memory and the computer program code are configured to, with the at least one processor, cause the second device at least to:
in response to receiving a data packet at the second device, determine, based on a processing pattern of a plurality of data flows for an egress port of a third device, whether the data packet is associated with the plurality of data flows, the processing pattern indicating an association between the plurality of data flows;
in accordance with a determination that the data packet is associated with the plurality of data flows, determine a sequence number of the data packet, the sequence number indicating a time order for transmitting the data packet from the egress port of the third device to a fourth device;
mark the data packet with the sequence number; and
transmit the marked data packet to the third device.

6. The second device of claim 5, wherein the second device is further caused to:
determine a property of the plurality of data flows based on the processing pattern, the property comprising at least one of the following: a direction of the plurality of data flows, a session identifier of a data unit session associated with the plurality of data flows, and indicators of the plurality of data flows;
determine identification information of the data packet; and
in accordance with a determination that the identification information matches the properties, determine the data packet is associated with the plurality of data flows.

7. The second device of claim 5, wherein the second device is caused to determine the sequence number by:
determining the number of data packets belonging to the plurality of data flows which have been arrived during a packet burst at the second device;
determining a time sequence of the data packet in the packet burst; and
determining the sequence number based on the number and the time sequence.

8. The second device of claim 5, wherein the second device is cause to mark the data packet by:
inserting the sequence number into a head of the data packet.

9. A third device, comprising:
at least one processor; and
at least one memory including computer program code;
the at least one memory and the computer program code are configured to, with the at least one processor, cause the third device at least to:
receive a data packet from a second device, the data packet being associated with a plurality of data flows to be transmitted from an egress port of the third device;
determine a sequence number of the data packet, the sequence number indicating a time order for transmitting the data packet from the egress port to a fourth device; and
transmit the data packet to the fourth device based on the sequence number, through the egress port.

10. The third device of claim 9, wherein the third device is further caused to:
remove the sequence number from the data packet before the transmission of the data packet before the through the egress port.

11. The third device of claim 9, wherein the third device is caused to determine the sequence number by:
determining the sequence number from a head of the data packet.

12. A method comprising:
in accordance with a determination that a plurality of data flows are to be transmitted from a second device to a third device, determining, at a first device, an egress port of the third device for the plurality of data flows to pass through based on a traffic class of the plurality of data flows;
determining a processing pattern of the plurality of data flows for the egress port, the processing pattern indicating an association between the plurality of data flows; and
providing the processing pattern to a second device.

13. The method of claim 12, wherein determining the processing pattern comprises:
determining a property of the plurality of data flows, the property comprising at least one of the following: a transmission direction of the plurality of data flows, a session identifier of a data unit session associated with the plurality of data flows, and indicators of the plurality of data flows;
setting a pattern identifier for the property of the plurality of data flows; and
determining the processing pattern based on the pattern identifier and the property of the plurality of data flows.

14. The method of claim 12, further comprising:
in accordance with a determination that a further data flow is to be transmitted from a second device to a third device, determining whether a further traffic class of the further data is same as the traffic class of the plurality of data flows;
in accordance with a determination that the further traffic class is same as the traffic class, determining a property of the further data flow; and
updating the processing pattern based on the property of the further data flow.

15. The method of claim 12, further comprising:
in accordance with a determination that the transmission of the plurality of data flows has been released, removing the property of the plurality of data flows from the processing pattern.

16. A method comprising:
in response to receiving a data packet at a second device, determining, based on a processing pattern of a plurality of data flows for an egress port of a third device, whether the data packet is associated with the plurality of data flows, the processing pattern indicating an association between the plurality of data flows;
in accordance with a determination that the data packet is associated with the plurality of data flows, determining a sequence number of the data packet, the sequence number indicating a time order for transmitting the data packet from the egress port of the third device to a fourth device;
marking the data packet with the sequence number; and
transmitting the marked data packet to the third device.

17. The method of claim 16, further comprising:
determining a property of the plurality of data flows based on the processing pattern, the property comprising at least one of the following: a direction of the plurality of data flows, a session identifier of a data unit session associated with the plurality of data flows, and indicators of the plurality of data flows;
determining identification information of the data packet; and
in accordance with a determination that the identification information matches the properties, determining the data packet is associated with the plurality of data flows.

18. The method of claim 16, wherein determining the sequence number comprises:
determining the number of data packets belonging to the plurality of data flows which have been arrived during a packet burst at the second device;
determining a time sequence of the data packet in the packet burst; and
determining the sequence number based on the number and the time sequence.

19. The method of claim 16, wherein marking the data packet comprises:
inserting the sequence number into a head of the data packet.

20. A method comprising:
receiving, at a third device, a data packet from a second device, the data packet being associated with a plurality of data flows to be transmitted from an egress port of the third device;
determining a sequence number of the data packet, the sequence number indicating a time order for transmitting the data packet from the egress port to a fourth device; and
transmitting the data packet to the fourth device based on the sequence number.

21. The method of claim 20, further comprising:
removing the sequence number from the data packet before the transmission of the data packet before the through the egress port.

22. The method of claim 20, wherein determining the sequence number comprises:
determining the sequence number from a head of the data packet.

23.-25. (canceled)

26. A computer program embodied on a non-transitory computer readable medium, said computer program comprising program instructions for causing an apparatus to perform at least the method claim 12.

27. A computer program embodied on a non-transitory computer readable medium, said computer program comprising program instructions for causing an apparatus to perform at least the method of claim 16.

28. A computer program embodied on a non-transitory computer readable medium, said computer program comprising program instructions for causing an apparatus to perform at least the method of claim 20.
